(19) United States
(12) Patent Application Publication
(10) Pub. No.: US 2003/0188048 A1
(43) Pub. Date: Oct. 2, 2003

(54) Image compensation method of image scanner

(76) Inventors: Chun-Jen Chen, Taichung (TW); Kuo-Jeng Wang, Kaohsiung City (TW)

Correspondence Address: POWELL, GOLDSTEIN, FRAZER & MURPHY LLP, P.O.BOX 97223, WASHINGTON, DC, 20090-7223, US

(21) Appl. No.: 10/105,484

(22) Filed: Mar. 26, 2002

(51) Int. Cl. G06F 3/00

(52) U.S. Cl. 710/8

(57) ABSTRACT

An image compensation method of an image scanner is disclosed. The method can automatically select either a host or the image scanner to execute image compensation according to the transfer speed between the host and the image scanner.

### BACKGROUND OF THE INVENTION

1. Field of the Invention

The present invention relates to an image compensation method of an image scanner, and more particularly to an image compensation method of an image scanner that can automatically select either the image scanner or a host to proceed image compensation according to the speed of I/O serial buses communicating the image scanner and the host.

2. Description of the Related Art

There are many types of computer peripheral device such as mouse, keyboard, printer and image scanner, etc. and each of the computer peripheral devices may use individual of I/O buses to communicate with a computer host. The computer host usually is connected to at least two computer peripheral devices with different I/O buses. Moreover, even single kind of computer peripheral device may comprise various I/O buses. For example, an image scanner may use an USB (Universal Serial Bus), an IEEE 1394 I/O serial bus or other parallel buses to communicate with a computer host, each of which has divergent speed. The data transfer speed of IEEE 1394 I/O serial bus could be up to 400 Mbytes/sec, however, the data transfer speed of USB 1.0 serial bus could be only 12 Mbytes/sec. The various data transfer speeds of various buses for the operation of an image scanner could be a troubling issue. Particularly, image compensation constantly performed either by a scanner or by a host in a conventional system will waste the system resource. For instance, if image compensation is constantly performed by a scanner and the data transfer speed is high, it would be necessary to spend more time to access compensation memories and the high transfer speed between the scanner and the host is wasted. In contrary, if image compensation is constantly performed by a host and the data transfer speed is low, it would be necessary to waste more time for the host to proceed image compensation processing and render the image data buffer of the scanner full.

In view of the drawbacks mentioned with the prior art, there is a continued need to develop new and improved image compensation method of image scanner that overcome the disadvantages associated with prior art. The requirements of this invention are that it solves the problems mentioned above.

### SUMMARY OF THE INVENTION

It is therefore an object of the invention to provide an image compensation method of an image scanner that can automatically select either a host or the image scanner to execute image compensation according to the transfer speed between the host and the image scanner.

It is another object of this invention to provide an image compensation method of an image scanner that can efficiently utilize system resource.

It is a further object of this invention to provide an image compensation method of an image scanner that can upgrade system efficiency and utilize data transfer bandwidth more efficiently.

To achieve these objects, and in accordance with the purpose of the invention, the invention provide an image compensation method of an image scanner. The method comprises sensing the data transfer speed of the bus communicating the image scanner and a host, determining, according to the data transfer speed, either the image scanner or the host to performs image compensation, scanning image and performing image compensation.

It is to be understood that both the foregoing general description and the following detailed description are exemplary and explanatory only and are not restrictive of the invention, as claimed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a block diagram of an image scanner; and

FIG. 2 shows a flow chart of an image compensation method of an image scanner in accordance with one embodiment of the invention.

### DESCRIPTION OF THE PREFERRED EMBODIMENT

It is to be understood and appreciated that the image compensation method of an image scanner described below do not cover a complete system and method. The present invention can be practiced in conjunction with various software and hardware that are used in the art, and only so much of the commonly practiced components and steps are included herein as are necessary to provide an understanding of the present invention.

The present invention will be described in detail with reference to the accompanying drawings. It should be noted that the drawings are in greatly simplified form.

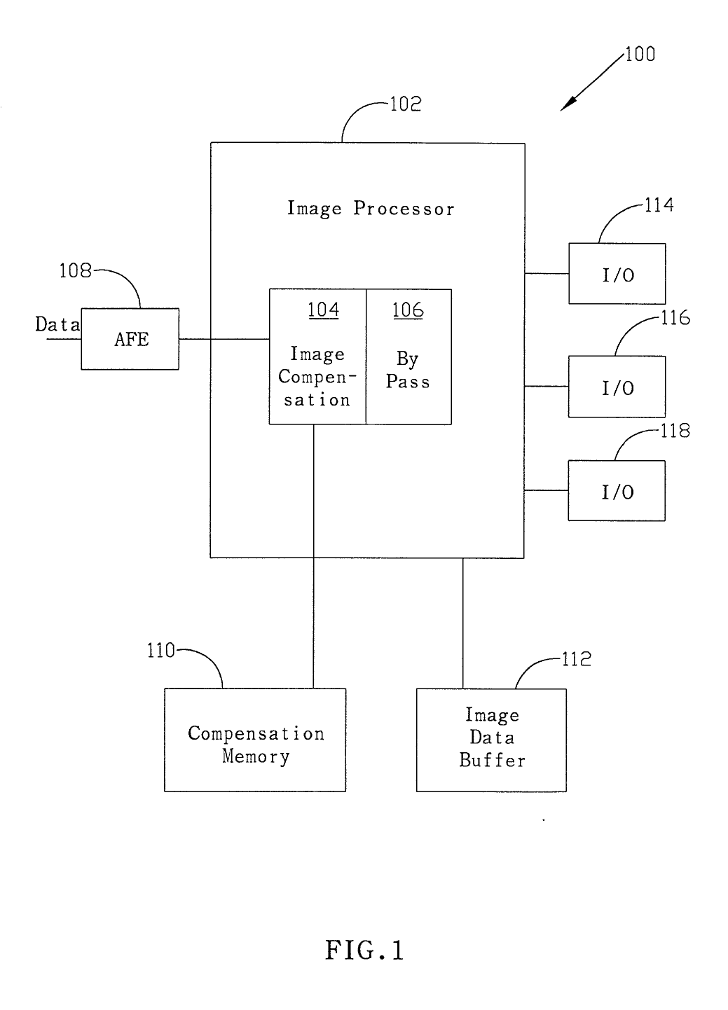

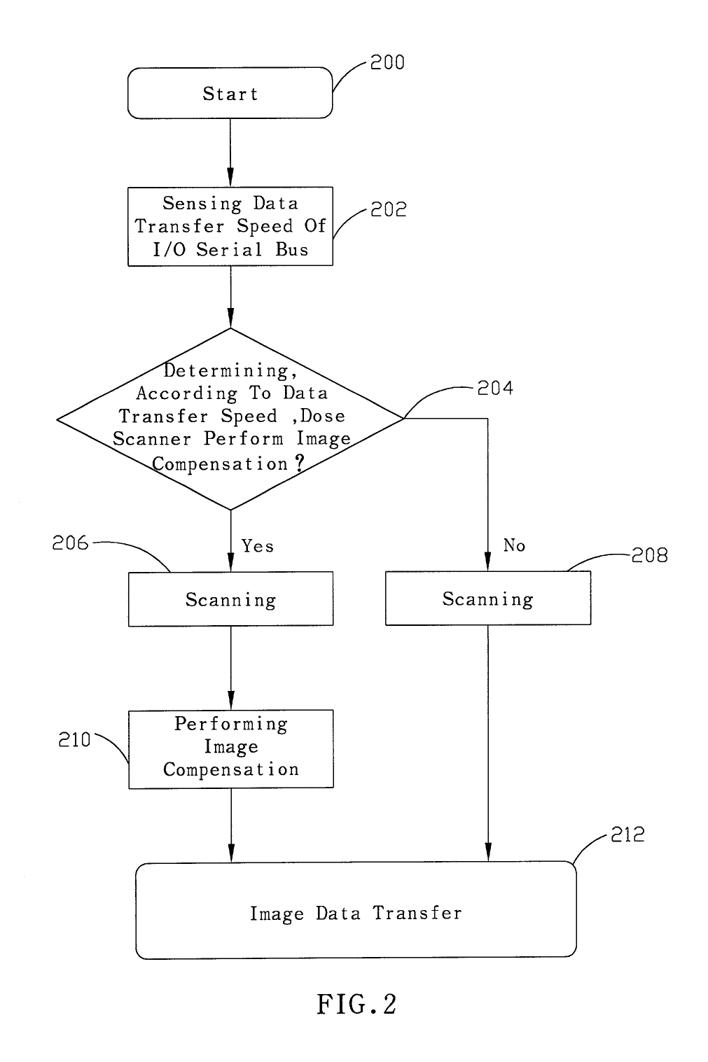

Referring to FIG. 1, a block diagram of an image scanner is shown. An image processor 102 comprising image compensation module 104 and bypass module 106, analog to digital converter (ADC) or AFE 108, compensation memory 110, image data buffer memory 112 and I/O port 114, 116 and 118. FIG. 2 shows a flow chart of an image compensation method of an image scanner in accordance with one embodiment of the invention. The image scanner starts up in step 200 and what kind of the I/O serial bus communicating the host as well as the transfer speed of I/O serial bus are sensed in step 202. The I/O port 114, 116 and 118 can be USB 1.0, USB 1.1, USB 2.0, IEEE 1394, EPP (Enhanced Parallel Port) and SCSI (Small Computer System Interface) ports. The image scanner then determines whether it will performs image compensation or not according to the transfer speed of I/O bus communicating the host in step 204. The bus can have at least one transfer speed. For example, an USB 2.0 serial bus can have three speed modes including HIGH-SPEED MODE, FULL-SPEED MODE and LOW-SPEED MODE. If the I/O bus has a high data transfer speed such as IEEE 1394, image compensation will be performed by the host. The image scanner then starts to scan in step 208 and the image data is transferred to the host in step 212. In contrary, if the I/O bus has a low data transfer speed such as USB 1.0, image compensation will be performed by the image scanner. The image scanner then starts to scan in step 206. After the scanning, the image scanner then performs image compensation in step 210. The image data is transferred to the host in step 212.

The image compensation method of an image scanner in accordance with one embodiment of the invention set forth can automatically select either the host or the image scanner to execute image compensation according to the I/O bus and the transfer speed between the host and the image scanner. If the I/O bus has a high data transfer speed, the high transfer speed between the scanner and the host can be efficiently utilized and the time spent to access compensation memories of the image scanner can be saved. In contrary, if the I/O bus has a low data transfer speed, the host would not have to wait for the slowly transferred image data and the image data buffer memory will not be full since the image scanner will automatically perform image compensation after scanning.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claim is:

1. An image compensation method of an image scanner, said method comprising:
sensing a data transfer speed of a bus communicating the image scanner and a host;
determining, according to said data transfer speed, either the image scanner or said host to performs image compensation;
scanning image; and
performing image compensation.

2. The method according to claim 1, wherein said bus communicating the image scanner and said host has at least one data transfer speed.

3. The method according to claim 1, wherein said bus communicating the image scanner and said host comprises an USB 1.0 serial bus.

4. The method according to claim 1, wherein said bus communicating the image scanner and said host comprises an USB 1.1 serial bus.

5. The method according to claim 1, wherein said bus communicating the image scanner and said host comprises an USB 2.0 serial bus.

6. The method according to claim 1, wherein said bus communicating the image scanner and said host comprises an IEEE 1394 serial bus.

7. The method according to claim 1, wherein said bus communicating the image scanner and said host comprises an Enhanced Parallel Port bus.

8. The method according to claim 1, wherein the serial bus communicating the image scanner and said host comprises a Small Computer System Interface bus.

9. The method according to claim 1, wherein the serial bus is an USB 2.0 serial bus with HIGH-SPEED MODE and the mean which performs image compensation is said host.

10. The method according to claim 1, wherein the serial bus is an USB 2.0 serial bus with FULL-SPEED MODE and the mean which performs image compensation is the image scanner.

11. An image compensation method of an image scanner, said method comprising:
sensing a data transfer speed of a bus with at least one data transfer speed communicating the image scanner and a host;
determining, according to said data transfer speed, either the image scanner or said host to performs image compensation;
scanning image; and
performing image compensation.

12. The method according to claim 11, wherein said bus comprises an IEEE 1394 serial bus.

13. The method according to claim 11, wherein said bus is an USB 2.0 serial bus with HIGH-SPEED MODE and the mean which performs image compensation is said host.

14. The method according to claim 11, wherein said bus is an USB 2.0 serial bus with FULL-SPEED MODE and the mean which performs image compensation is the image scanner.

15. An image compensation method of an image scanner, said method comprising:
sensing a data transfer speed of an USB 2.0 serial bus with at least one data transfer speed communicating the image scanner and a host;
determining, according to the data transfer speed, either the image scanner or said host to performs image compensation;
scanning image; and
performing image compensation.

16. The method according to claim 15, wherein said USB 2.0 serial bus is in HIGH-SPEED MODE and the mean which performs image compensation is said host.

17. The method according to claim 15, wherein said USB 2.0 serial bus is in FULL-SPEED MODE and the mean which performs image compensation is the image scanner.

18. The method according to claim 15, wherein said USB 2.0 serial bus is in LOW-SPEED MODE and the mean which performs image compensation is the image scanner.
